(19) United States
(12) Patent Application Publication
(10) Pub. No.: US 2014/0258937 A1
(43) Pub. Date: Sep. 11, 2014

(54) METHOD FOR CONTROLLING DISPLAY AND AN ELECTRONIC DEVICE THEREOF

(71) Applicant: Samsung Electronics Co., Ltd., Suwon-si (KR)

(72) Inventor: Ho-Shin LEE, Yongin-si (KR)

(73) Assignee: Samsung Electronics Co., Ltd., Suwon-si (KR)

(21) Appl. No.: 14/199,114

(22) Filed: Mar. 6, 2014

(30) Foreign Application Priority Data
Mar. 11, 2013 (KR) 10-2013-0025717

(51) Int. Cl. G06F 3/0482; G06F 3/0488

(52) U.S. Cl. CPC G06F 3/0482; G06F 3/0488
USPC 715/835

(57) ABSTRACT

An apparatus and a method for displaying a shortcut object in a locked electronic device are provided. A method for controlling a lock function of the electronic device includes detecting a touch input for displaying at least one shortcut object list in a lock screen, displaying a preset shortcut object list according to the detected touch input in a lock mode, selecting at least one shortcut object of the shortcut object list, and executing an application corresponding the selected shortcut object.

### CROSS-REFERENCE TO RELATED APPLICATION(S)

This application claims the benefit under 35 U.S.C. §119(a) of a Korean patent application filed on Mar. 11, 2013 in the Korean Intellectual Property Office and assigned Serial number 10-2013-0025717, the entire disclosure of which is hereby incorporated by reference.

### TECHNICAL FIELD

The present disclosure relates to a method for controlling a screen of an electronic device and the electronic device thereof. More particularly, the present disclosure relates to a method and an apparatus for displaying a shortcut object.

### BACKGROUND

An electronic device, which becomes necessities in the modern life on account of a portability thereof, is evolving into a multimedia device which provides various services such as a voice and video communication function, an information input/output function, and a data storing function.

As the electronic device provides a multimedia service, information to process and to display increases. Accordingly, an electronic device including a touch screen for expanding a display size by enhancing spatial utilization is drawing more attention.

The touch screen is an input and display device for inputting and displaying information on a single screen. Hence, the use of the touch screen allows for an increased display area on the electronic device by removing the need for a separate input device such as keypad. For example, with a full-touch type which uses the entire screen as the touch screen, the front side of the electronic device can be used as the screen to thus expand the screen size.

Further, an input tool such as a stylus pen, a digital pen, and/or the like may be used with an electronic device in which the touch screen is implemented to create text or draw a line.

In addition, an electronic device in which the touch screen is implemented may provide a touch lock function for preventing a touch malfunction and enhancing security of the electronic device. The touch lock function is used not only to address the malfunction and the security but also to reduce unnecessary power consumption.

According to the related art, a locked electronic device releases the lock by detecting a user input of a preset rule such as an image movement, a password, and pattern matching for the unlocking.

According to the related art, the electronic device typically sets the lock function by displaying an image designated as the lock function. After releasing the lock function, the electronic device displays a User Interface (UI) corresponding to a plurality of applications. When a user of the electronic device wants to check an e-mail, capture an image, or check an address book in the lock mode, the user can release the lock function and then execute an application by tapping the application or by generating a preset gesture in the UI displayed after the lock release. However, according to the related art, the user releases the lock function and then directly executes the application in the displayed UI. When more icons are displayed, executing the application intended by the user may be cumbersome.

To address such a shortcoming, according to the related art, the electronic device also displays an icon for executing the application in the image of the lock function. In this case, the user of the electronic device can execute the application corresponding to the icon by making a gesture for the icon. However, a type and a number of the displayed icons are limited in the image of the lock function, and the icon displayed in the image (a lock screen) of the lock function ruins the image. In addition, when the icon is displayed together with the image of the lock function, a particular application is executed contrary to the user intention for releasing the lock function or the lock function is released contrary to the user intention for running a particular application.

To address this drawback, the locked electronic device requires an apparatus and a method for quickly and accurately executing a particular function or a particular application.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for executing a particular function or a particular application quickly and accurately in a locked electronic device.

Another aspect of the present disclosure is to provide an apparatus and a method for displaying a shortcut object list in a locked electronic device.

Another aspect of the present disclosure is to provide an apparatus and a method for displaying a shortcut object when a lock function is released in a locked electronic device.

Another aspect of the present disclosure is to provide an apparatus and a method for providing status notification information in a locked electronic device.

Another aspect of the present disclosure is to provide an apparatus and a method for controlling displayed information using status change in a locked electronic device.

In accordance with an aspect of the present disclosure, a method for controlling a screen of an electronic device is provided. The method includes detecting a screen touch input, determining whether the screen touch input is to release the lock of the screen or to display at least one shortcut object in the lock mode, when detecting the screen touch input for displaying the at least one shortcut object, displaying at least one shortcut object, selecting at least one of the at least one shortcut object, and executing an application corresponding to the selected shortcut object.

In accordance with an aspect of the present disclosure, the shortcut object may be at least one unreceived object displayed on the lock screen of the electronic device.

In accordance with an aspect of the present disclosure, the screen touch input for displaying the at least one shortcut object may touch the lock screen in a preset pattern.

In accordance with an aspect of the present disclosure, the displayed at least one shortcut object may be a separate layer which is popped up in part of the lock screen.

In accordance with an aspect of the present disclosure, the displayed at least one shortcut object may be displayed in the whole screen of the electronic device.

In accordance with an aspect of the present disclosure, the displayed at least one shortcut object may be positioned along at least one screen edge of the screen of the electronic device.

In accordance with an aspect of the present disclosure, the positioned at least one shortcut object may be status notification information indicating a status of the electronic device.

In accordance with an aspect of the present disclosure, the positioned at least one shortcut object may be hidden according to a motion detected in the electronic device.

In accordance with an aspect of the present disclosure, the displayed at least one shortcut object may be status notification information indicating a status of the electronic device.

In accordance with an aspect of the present disclosure, the at least one shortcut object may be aligned according to user setting.

In accordance with an aspect of the present disclosure, the at least one shortcut object may be added and deleted according to the user setting.

In accordance with an aspect of the present disclosure, the at least one shortcut object may be aligned based on at least one of frequency of use and recent use.

In accordance with an aspect of the present disclosure, after the at least one shortcut object is displayed, when a certain time passes, the lock screen may be displayed again or a current screen may be turned off.

In accordance with an aspect of the present disclosure, the displayed at least one shortcut object may be hidden according to a touch input of a user in a particular region.

In accordance with an aspect of the present disclosure, the displayed at least one shortcut object may be scrolled using drag or a separate scroll bar.

In accordance with another aspect of the present disclosure, an apparatus of an electronic device for controlling a screen is provided. The apparatus includes a display, and at least one processor. The processor controls to detect a screen touch input, to determine whether the screen touch input is to release the lock of the screen or to display at least one shortcut object in the lock mode, when detecting the screen touch input for displaying the at least one shortcut object, to display at least one shortcut object, to select at least one of the at least one shortcut object, and to execute an application corresponding to the selected shortcut object.

In accordance with an aspect of the present disclosure, the at least one processor may control to display at least one unreceived object displayed on the lock screen of the electronic device, as the at least one shortcut object.

In accordance with an aspect of the present disclosure, the at least one processor may control to display the at least one shortcut object by touching the lock screen in a preset pattern.

In accordance with an aspect of the present disclosure, the at least one processor may control to display the at least one shortcut object in a separate layer which is popped up in part of the lock screen.

In accordance with an aspect of the present disclosure, the at least one processor may control to display the at least one shortcut object in the whole screen of the electronic device.

In accordance with an aspect of the present disclosure, the at least one processor may control to display the at least one shortcut object which is positioned along at least one screen edge of the screen of the electronic device.

In accordance with an aspect of the present disclosure, the at least one processor may control to display status notification information indicating a status of the electronic device, as the positioned at least one shortcut object.

In accordance with an aspect of the present disclosure, the at least one processor may control to hide the positioned at least one shortcut object according to a motion detected in the electronic device.

In accordance with an aspect of the present disclosure, the at least one processor may control to display status notification information indicating a status of the electronic device, as the at least one shortcut object.

In accordance with an aspect of the present disclosure, the at least one processor may control to align the at least one shortcut object according to user setting.

In accordance with an aspect of the present disclosure, the at least one processor may control to add or delete the at least one shortcut object according to the user setting.

In accordance with an aspect of the present disclosure, the at least one processor may control to align the at least one shortcut object based on at least one of frequency of use and recent use.

In accordance with an aspect of the present disclosure, after the at least one shortcut object is displayed, when a certain time passes, the at least one processor may control to display the lock screen again or turn off a current screen.

In accordance with an aspect of the present disclosure, the at least one processor may control to scroll the displayed at least one shortcut object according to a touch input of a user in a particular region.

In accordance with an aspect of the present disclosure, the processor may control to scroll the displayed shortcut object using drag or a separate scroll bar.

In accordance with another aspect of the present disclosure, a method for controlling a screen of an electronic device is provided. The method includes detecting a touch input for displaying status notification information, displaying the status notification information according to the detected touch input, determining whether a motion of the electronic device for controlling the displayed status notification information is detected, and when detecting the motion for controlling the status notification information, hiding the displayed status notification information.

In accordance with an aspect of the present disclosure, the motion of the electronic device may include at least one of shaking in one direction, turning, and tilting of the electronic device.

In accordance with an aspect of the present disclosure, the motion of the electronic device may be determined using at least one of an acceleration sensor and a gyro sensor.

In accordance with an aspect of the present disclosure, the displayed status notification information may be a separate layer displayed in all or part of the screen.

In accordance with another aspect of the present disclosure, a method for controlling a lock function of an electronic device that comprises a touch screen is provided. The method includes detecting an input to the touch screen, determining whether the detected input corresponds to a preset input for displaying a shortcut object from a lock screen, displaying the shortcut object from the lock screen according to the detected input, detecting an input for selecting the shortcut object, and executing a function corresponding to the selected shortcut object.

Other aspects, advantages, and salient features of the present disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device for displaying a shortcut object according to an embodiment of the present disclosure;

FIG. 2 is a flowchart of a method for displaying a shortcut object in an electronic device according to an embodiment of the present disclosure;

FIG. 3 is a flowchart of a method for controlling status notification information in an electronic device according to an embodiment of the present disclosure;

FIGS. 4A, 4B, and 4C are diagrams of screens of an electronic device for executing an application using a shortcut object according to an embodiment of the present disclosure;

FIGS. 5A, 5B, and 5C are diagrams of screens of an electronic device for executing an application using a shortcut object according to an embodiment of the present disclosure;

FIGS. 6A, 6B, and 6C are diagrams of screens of an electronic device for executing an application using a shortcut object according to an embodiment of the present disclosure;

FIG. 7A is a diagram of lock release by controlling a lock screen in an electronic device according to an embodiment of the present disclosure;

FIG. 7B is a diagram of the lock release by controlling a lock screen in an electronic device according to an embodiment of the present disclosure;

FIG. 8A is a diagram of a lock release by controlling a lock screen in an electronic device according to an embodiment of the present disclosure;

FIG. 8B is a diagram of a lock release by controlling a lock screen in an electronic device according to an embodiment of the present disclosure;

FIG. 9A is a diagram of a lock release by controlling a lock screen in an electronic device according to an embodiment of the present disclosure;

FIG. 9B is a diagram of a lock release by controlling a lock screen in an electronic device according to an embodiment of the present disclosure;

FIGS. 10A and 10B are diagrams of lock screen control in an electronic device according to an embodiment of the present disclosure;

FIGS. 11A, 11B, and 11C are diagrams of a lock screen control in an electronic device according to an embodiment of the present disclosure;

FIGS. 12A and 12B are diagrams of a displayed status notification information controlled in an electronic device according to an embodiment of the present disclosure;

FIGS. 13A and 13B are diagrams of a displayed status notification information controlled in an electronic device according to an embodiment of the present disclosure;

FIGS. 14A and 14B are diagrams of a screen defining a shortcut object in an electronic device according to an embodiment of the present disclosure;

FIG. 15A is a flowchart of a method for controlling a screen in an electronic device according to an embodiment of the present disclosure; and

FIG. 15B is a diagram of an apparatus of an electronic device for controlling a screen according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Herein, a touch on a screen (e.g., touch screen) can include a gesture on the screen. The gesture on the screen indicates a touch pattern on the touch screen of an electronic device. An external input means such as a user's finger, a stylus pen, and/or the like applies the touch onto the touch screen of the electronic device, and the gesture indicates a drag of a certain pattern while the touch is maintained. In some cases, the gesture may include a tap touch, a long touch, a touch-and-drag, a touch release, and/or the like.

Hereinafter, various embodiments of the present disclosure provide an apparatus and a method for quickly and accurately executing a particular function or a particular application by displaying a shortcut object when a lock function is set or released, and displaying status notification information in the locked mode.

The shortcut object corresponds to an object (e.g., an icon, a menu, and/or the like) for executing a function or an application of the electronic device, and the status notification information notifies the status (e.g., a new message reception, an update application information, and/or the like) of the electronic device or the setting of a major function (e.g., wireless Local Area Network (LAN), Bluetooth, Global Positioning System (GPS), and/or the like).

According to various embodiments of the present disclosure, the electronic device can employ a portable electronic device such as portable terminal, mobile phone, media player, tablet computer, handheld computer, or Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like. The electronic device may be a portable electronic device combining two or more functions of those devices. According to various embodiments of the present disclosure, an electronic device may include communication functionality.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

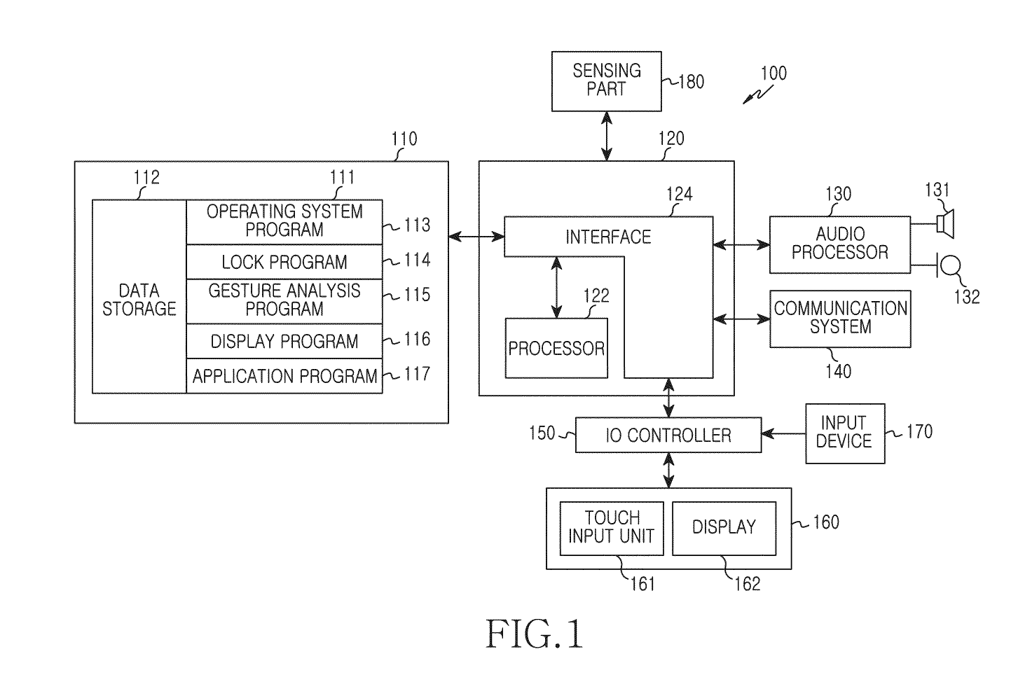

FIG. 1 is a block diagram of an electronic device for displaying a shortcut object according to an embodiment of the present disclosure.

As shown in FIG. 1, the electronic device 100 can include a memory 110, a processor unit 120, an audio processor 130, a communication system 140, an Input/Output (I/O) controller 150, a touch screen 160, an input device 170, and a sensing part 180. According to various embodiments of the present disclosure, the electronic device 100 can include a plurality of at least one of the aforementioned components. For example, the electronic device 100 can include a plurality of memories, or a plurality of communication systems.

The memory 110 can include a program storage 111 for storing a program to control operations of the electronic device 100, and a data storage 112 for storing data generating in program execution. For example, the data storage 112 stores updatable data such as a phonebook, an outgoing message, and an incoming message. The data storage 112 stores input information for releasing the lock function, and input information for displaying the shortcut object or hiding the shortcut object. Further, the data storage 112 stores input information for displaying the status notification information, and input information for controlling (e.g., to scroll the status notification information, to hide the status notification information, and/or the like) the displayed status notification information. According to various embodiments of the present disclosure, the input information can include a user's motion (e.g., a motion for changing the device status), an input pattern (e.g., touch input type), and/or the like.

The program storage 111 can include an operating system program 113, a lock program 114, a gesture analysis program 115, a display program 116, and at least one application program 117. According to various embodiments of the present disclosure, the program in the program storage 111 may be referred to as an instruction set which is a set of instructions.

The operating system program 113 can include various software components for controlling general system operations. For example, the general system operations that may be controlled by the various software components may include a memory management and control, a storage hardware (device) control and management, a power control and management, and/or the like. The operating system program 113 processes normal communication between various hardware (devices) and software components (modules).

The lock program 114 can include at least one software component for controlling the lock function of the electronic device 100. For example, when a user input is not detected during a preset reference time or a user input for the lock function is detected, the lock program 114 activates the lock function to block an unnecessary touch input not intended by the user. In contrast, when a user input (e.g., a predefined pattern input) for releasing the lock is detected, the lock program 114 processes to release the lock. According to various embodiments of the present disclosure, the user input for releasing the lock is determined by the gesture analysis program 115.

The gesture analysis program 115 can include at least one software component for recognizing the user input to control the lock function.

For example, the gesture analysis program 115 analyses the input pattern (e.g., the touch input type) detected in the lock mode and determines the input for releasing the lock or the input for displaying the shortcut object. In addition, the gesture analysis program 115 analyzes the user input pattern and/or the motion of the electronic device, and determines the user input for controlling a status notification function. According to various embodiments of the present disclosure, the input for displaying the shortcut object indicates the user input for displaying the shortcut object in the lock mode and/or the unlock mode, and the status notification function provides a notification of the status (e.g., a new message reception, a update application information, and/or the like) of the electronic device 100, and/or the setting of the major function (e.g., wireless LAN, Bluetooth, GPS, and/or the like).

The electronic device 100 can display a lock screen (image) divided into a region (image) for releasing the lock and a region (image) for displaying the shortcut object, so as to notify the lock mode.

According to various embodiments of the present disclosure, the gesture analysis program 115 can detect the region of the detected user input and thus classify the user input.

Further, the electronic device 100 can prestore an input pattern for releasing the lock and an input pattern for displaying the shortcut object.

According to various embodiments of the present disclosure, in the lock mode (the displayed lock screen), the gesture analysis program 115 can classify the user input by comparing the detected input pattern (e.g., the touch input type) and the prestored input pattern. The gesture analysis program 115 can identify the user input for displaying the shortcut object or for hiding the shortcut object using sensing information (e.g., tilt information, rotation information, and/or the like) obtained by the sensing part 180.

The electronic device 100 prestores the input pattern and/or the motion information for displaying the status notification information in the lock mode and/or the unlock mode, and stores the motion information for hiding the status notification information.

Accordingly, the gesture analysis program 115 can analyze the motion and/or the input pattern detected in the lock mode or the unlock mode, and classify the user input for controlling (displaying or hiding) the status notification information. According to various embodiments of the present disclosure, the gesture analysis program 115 can identify the user input for controlling the status notification information using the sensing information (e.g., tilt information, rotation information, and/or the like) obtained by the sensing part 180.

The user input classified by the gesture analysis program 115 is used to execute the display program 116.

The display program 116 can include various software components for providing and displaying graphics on the touch screen 160. The term ‘graphics’ embraces a text, a webpage, an icon, a digital image, a video, an animation, and/or the like.

The display program 116 can include various software components relating to a user interface.

For example, when confirming a condition for setting the lock (e.g., when detecting the input for executing the lock function or detecting no user input during a certain time), the display program 116 displays the lock screen and notifies the lock mode.

When the user input for releasing the lock in the lock mode is detected, the display program 116 displays a user interface corresponding to a plurality of applications and thus notifies the lock release.

When the user input for displaying the shortcut object in the lock mode is detected, the display program 116 displays a predefined shortcut list. In so doing, the display program 116 displays a pop-up shortcut object in the interface of the unlock mode.

For example, the display program 116 can display a page including the shortcut object in the interface of the unlock mode.

For example, the display program 116 can display the shortcut object in the lock screen.

The display program 116 displaying the shortcut object can hide the shortcut object in the screen after a certain (e.g., preset) time. Notably, when detecting the user input for hiding the shortcut object, the display program 116 can hide the shortcut object.

When the user input for displaying the status notification information is detected, the display program 116 displays the status notification information. When the motion for hiding the status notification information is detected, the display program 116 processes to make the displayed status notification information disappear from the screen.

In the lock screen, the display program 116 can display the status notification information. The display of the status notification information in the lock screen omits the lock release to display the status notification information, thus reducing unnecessary power consumption (e.g., the power consumed for the lock release) and allowing the user to quickly check the status notification information.

When the shortcut object is displayed and the user input for selecting at least one shortcut object is detected, the display program 116 displays the execution screen of the application or the function of the selected shortcut object. The display program 116 can detect the user input for the status notification information and display the information selected by the user.

The application program 117 can includes a software component for at least one application program installed in the electronic device 100. The shortcut object and the status notification information can be controlled through the application, and the application can be part of the application program 117.

The program in the program storage 111 can be operated using hardware. For example, the electronic device 100 can include a lock module, a gesture analysis module, and a display module.

The processor unit 120 can include at least one processor 122 and an interface 124. Herein, the processor 122 and the interface 124 can be integrated onto at least one integrated circuit or embodied separately.

The interface 124 may function as the memory interface for controlling access of the processor 122 and the memory 110. The interface 124 may function as a peripheral interface for controlling connections between an I/O peripheral of the electronic device 100, and the processor 122.

The processor 122 performs various functions for the electronic device 100 using the at least one program stored in the memory 110, and processes and controls voice communication and data communication. In addition to performing the voice communication and data communication functions and/or other typical functions, the processor 122 may be implemented to control the electronic device 100 to perform the method of the various embodiments of the present disclosure in association with the lock program 114, the gesture analysis program 115, and the display program 116 stored in the memory 110.

For example, the processor 122 can include a processor for determining the user input, and a processor for displaying the shortcut object, and can execute a particular application or a particular function using the shortcut object in the lock mode and/or in the unlock mode. For example, the shortcut object display function of the electronic device 100 can be fulfilled using the software such as program stored in the memory 110 or the hardware such as processor.

For example, the processor 122 can include a processor for detecting the user motion (or the status change of the electronic device 100), and a processor for displaying the status notification information or for hiding the status notification information. For example, the status notification information control function of the electronic device 100 can be performed using software such as a program stored in the memory 110, or hardware such as processor.

The audio processor 130 provides an audio interface between the user and the electronic device 100 through a speaker 131, a microphone 132, and/or the like.

The communication system 140 processes voice communication and data communication of the electronic device 100. The communication system 140 may be divided into a plurality of communication submodules for supporting different communication networks. For example, the communication networks may include, but is not limited to, a Global System for Mobile communication (GSM) network, an Enhanced Data GSM Environment (EDGE) network, a Code Division Multiple Access (CDMA) network, a Wideband-CDMA (W-CDMA) network, a Long Term Evolution (LTE) network, an Orthogonal Frequency Division Multiple Access (OFDMA) network, a wireless LAN, a Bluetooth network, Near Field Communication (NFC), an infrared communication, and/or the like.

The I/O controller 150 provides an interface between an I/O device such as the touch screen 160, the input device 170, and/or the like, and the interface 124.

The touch screen 160 is an I/O device for outputting and inputting information. The touch screen 160 can include a touch input unit 161 and a display 162.

The touch input unit 161 provides touch information detected through a touch panel, to the processor unit 120 via the I/O controller 150. According to various embodiments of the present disclosure, the touch input unit 161 changes the touch information to an instruction such as a touch_down, a touch_move, a touch_up, and/or the like, and provides the instruction to the processor unit 120. The touch input unit 161 generates the input for displaying the shortcut object or the status notification information.

The display 162 displays status information of the electronic device 100, a character input by the user, a moving picture, and a still picture. For example, the display 162 displays the shortcut object in the lock screen or the unlock screen, and displays the screen of the function or the application corresponding to the shortcut object selected by the user. The display 162 displays the status notification information, and hides the status notification information according to the user motion.

The input device 170 provides input data generated by the user selection to the processor unit 120 through the I/O controller 150. For example, the input device 170 may include only a control button to control the electronic device 100. For example, the input device 170 may include a keypad for receiving the input data from the user. The input device 170 issues (e.g., generates) input data for setting or releasing the lock function, and input data for displaying the shortcut object. The input device 170 issues (e.g., generates) input data for displaying the status notification information in the lock mode or the unlock mode.

The sensing part 180 obtains information used to determine the user input information for controlling the shortcut object or the status notification information. For example, the sensing part 180 can include a sensor for obtaining (e.g., detecting) tilt information of the electronic device 100, and a sensor for obtaining (e.g., detecting) rotation information of the electronic device 100. The information acquired by the sensing part 180 is provided to the gesture analysis program 115 to determine the user input information for controlling the shortcut object or the status notification information.

The electronic device 100 can further include components (not shown) for providing additional functions, such as a camera module for capturing the image or the video, a broadcasting receiver module for receiving the broadcasting, a digital music player module such as MP3 module, a close-range wireless communication module for close-range wireless communication, a proximity sensor module for detecting proximity, and/or the like, and software for the aforementioned components (e.g., modules).

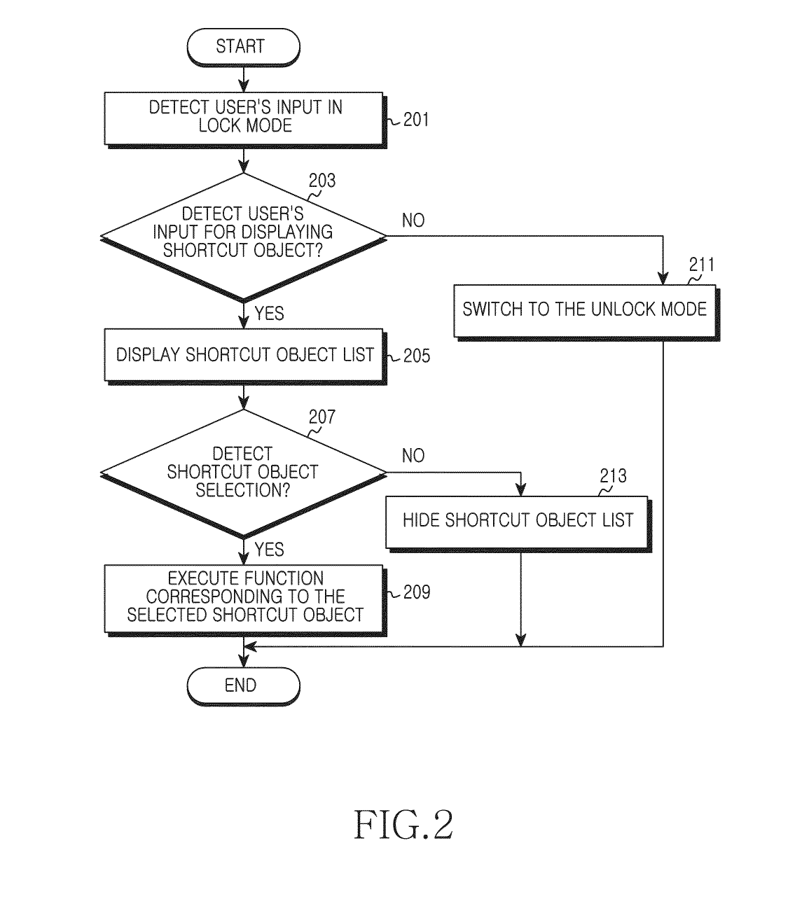

FIG. 2 is a flowchart of a method for displaying a shortcut object in an electronic device according to an embodiment of the present disclosure.

Referring to FIG. 2, at operation 201, the electronic device detects the user input in the lock mode.

At operation 203, the electronic device determines whether the detected user input is to display the shortcut object or to release the lock. For example, the electronic device determines whether to release the lock or to display the shortcut object based on the detected user input. The shortcut object indicates the function or application information (e.g., icon or menu) of the electronic device 100 which can be executed immediately in the lock mode. The user intended shortcut object can be listed. Further, function or application objects used (recently used) or used most during a certain time period can be listed. According to various embodiments of the present disclosure, the shortcut object list is not limited to the aforementioned lists, and can be generated in various fashions such as priority. For example, the application used less frequently but for used a long time may be given a higher priority, and the user can generate the shortcut object based on the priority of the applications.

Because the function or the application of the electronic device is executed through the shortcut object, the user does not have to release the lock and thereafter find and execute the function or the application to control in person.

According to various embodiments of the present disclosure, the electronic device can confirm the user input for displaying the shortcut object by detecting the input to the image for the shortcut object display or the preset input for the shortcut object display.

If the electronic device determines that the detected input is to release the lock (e.g., when the user input for releasing the lock is detected) at operation 203, the electronic device proceeds to operation 211 at which the electronic device releases the lock.

At operation 211, the lock mode is switched to the unlock mode, and the displayed lock screen is changed to the screen displaying the user interface corresponding to the multiple applications.

In contrast, if the electronic device determines that the detected input is to display the shortcut object (e.g., when the user input for displaying the shortcut object is detected) at operation 203, the electronic device proceeds to operation 205 at which the electronic device displays the shortcut object. Thereafter, the electronic device proceeds to operation 207.

At operation 207, the electronic device determines whether the user input for selecting the displayed shortcut object is detected. According to various embodiments of the present disclosure, the shortcut object selected by the user corresponds to the application or the function to be executed by the user among the output shortcut objects.

According to various embodiments of the present disclosure, the electronic device can display the shortcut object in the lock mode (in the lock screen), or display the shortcut object after releasing the lock.

The electronic device can display the pop-up shortcut object or the page including the shortcut object. Such a shortcut object display function can be activated or deactivated according to user settings.

If the electronic device determines that the user input for selecting the displayed shortcut object is not detected (e.g., when no user input for selecting the shortcut object is detected) at operation 207, the electronic device processes to hide the shortcut object in operation 213. For example, the hiding of the shortcut object implies that the electronic device returns to the status before the shortcut object is displayed. The electronic device can display the shortcut object only while a timer operates, and can hide the shortcut object when the timer expires. For example, the displayed shortcut object can disappear from the screen. For example, when, after the shortcut object is displayed, the user input to a menu (close menu) for hiding the shortcut object or the user input outside the shortcut object is detected, the electronic device can hide the shortcut object.

In contrast, if the electronic device determines that the user input for selecting the displayed shortcut object is detected (e.g., when the user input for selecting the shortcut object is detected) at operation 207, then the electronic device may proceed to operation 209 at which the electronic device executes the function or the application corresponding to the shortcut object selected by the user. Thereafter, the electronic device finishes the process of displaying the shortcut object.

For example, still referring to FIG. 2, when the lock function is released, the electronic device can list and display the shortcut objects of a camera, a call, a message, a web browser, and/or the like, which are frequently used by the user, and the user can execute an intended application at the same time as the lock release. Further, the electronic device can display the shortcut object even in the lock mode. In this case, the electronic device confirms that the user selects at least one of the displayed shortcut objects, releases the lock, and executes the application or the function corresponding to the shortcut object selected by the user.

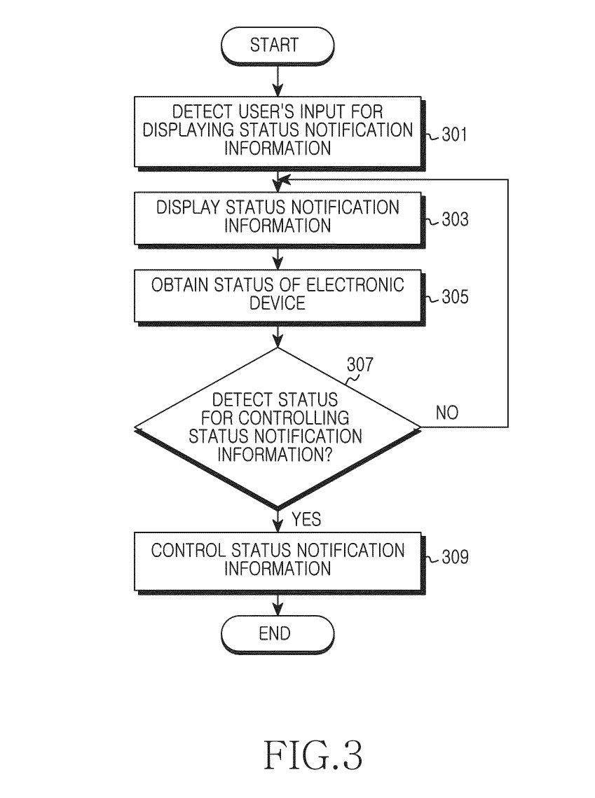

FIG. 3 is a flowchart of a method for controlling a status notification information in an electronic device according to an embodiment of the present disclosure.

Referring to FIG. 3, at operation 301, the electronic device detects the user input for displaying the status notification information.

At operation 303, the electronic device displays the status notification information. The status notification function notifies the status (e.g., a new message reception, update application information, and/or the like) of the electronic device 100 and/or the setting of the major function (e.g., wireless LAN, Bluetooth, GPS, and/or the like). The user input can be detected in the lock mode or the unlock mode. According to various embodiments of the present disclosure, when detecting the user input in the lock mode, the electronic device can display the status notification information by creating a separate layer on the displayed lock screen.

At operation 305, the electronic device determines a status thereof by obtaining (e.g., detecting) the tilt information or the rotation information.

At operation 307, the electronic device determines whether the status for controlling the status notification information is detected. According to various embodiments of the present disclosure, when the electronic detecting the tilt or the rotation over a threshold, the electronic device can determine the status for controlling the displayed status notification information.

If the electronic device determines that the status for controlling the status notification information is not detected at operation 307, the electronic device proceeds to operation 303 at which the electronic device maintains the status notification information display.

In contrast, when the electronic device determines the status for controlling the status notification information is detected at operation 307, then the electronic device proceeds to operation 309 at which the electronic device can control the status notification information. According to various embodiments of the present disclosure, the status notification information can be controlled by hiding or scrolling the displayed status notification information.

After controlling the displayed status notification information according to the status of the electronic device, the electronic device finishes the process of controlling status notification information.

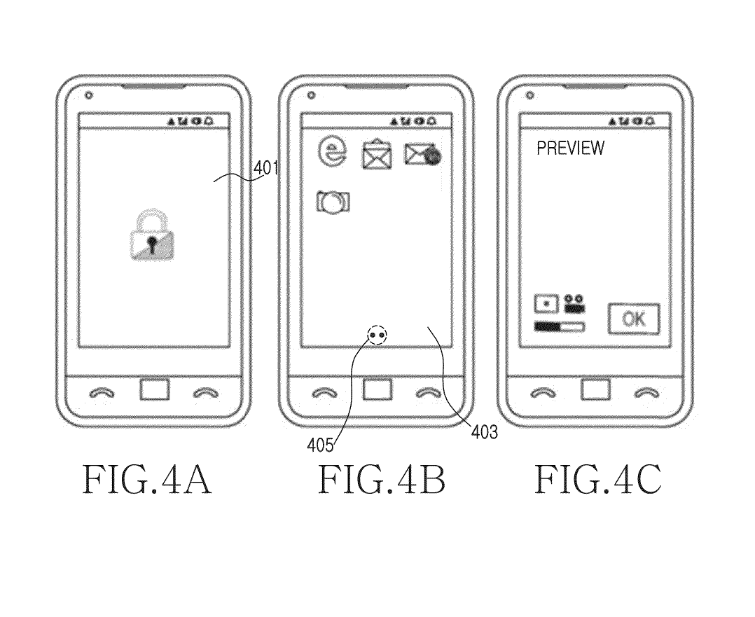

FIGS. 4A, 4B, and 4C are diagrams of screens of an electronic device for executing an application using a shortcut object according to an embodiment of the present disclosure.

Referring to FIGS. 4A to 4C, the electronic device releases the lock according to the user input, and then displays the page including the shortcut objects. For example, the electronic device displays the page-type shortcut objects in the interface of the unlock mode.

Referring to FIG. 4A, the electronic device displays a lock screen 401 indicating the lock mode.

When the lock screen is displayed, the electronic device can release the lock function according to the user input, or can release the lock function and concurrently display the shortcut object.

The shortcut object can be displayed when the user input to the preset image (e.g., in the lock screen) or the input of a preset type (e.g., pattern) is detected.

Upon detecting the input for displaying the shortcut object, the electronic device can display a page 403 including the shortcut objects as shown in FIG. 4B. The shortcut objects corresponding to the web browser, the message, the e-mail, and the camera function are grouped and displayed in the single page. According to various embodiments of the present disclosure, the shortcut objects may include objects corresponding to various other functions. The electronic device can also display information 405 about the page of the shortcut object. For example, the page information of the shortcut object may indicate the number of shortcut object pages. For example, the information (two circles) 405 indicates two shortcut object pages, and implies that another page exists in addition to the current shortcut object page displayed.

The display of the shortcut object implies that the lock function is released and concurrently that the particular application or function is ready to execute. The display of the shortcut object thus helps the user to omit the check on the particular application to execute while turning over the page including the user interface. In other words, display of the shortcut object eliminates the need for the user to navigate the user interface to search for the particular application to execute.

Accordingly, the user selects the shortcut object corresponding to the application or the function to execute from the displayed shortcut objects, and, as shown in FIG. 4C, the electronic device executes the application corresponding to the shortcut object selected by the user. As illustrated in FIG. 4C, the user has selected the shortcut object corresponding to the camera function from the displayed shortcut objects, and the electronic device executes the camera function.

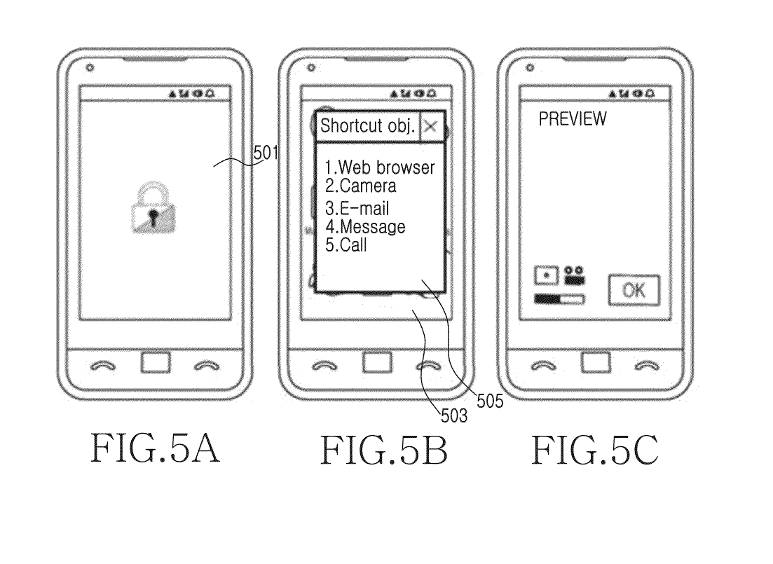

FIGS. 5A, 5B, and 5C depict screens of an electronic device for executing an application using a shortcut object according to another embodiment of the present disclosure.

Referring to FIGS. 5A, 5B, and 5C, the electronic device releases the lock according to the user input, and then displays the pop-up shortcut objects. For example, the electronic device displays the pop-up shortcut objects in the interface of the unlock mode.

Referring to FIG. 5A, the electronic device displays a lock screen 501 indicating the lock mode.

When the lock screen is displayed, the electronic device can release the lock function according to the user input, or can release the lock function and display the shortcut object at the same time.

The shortcut object can be displayed when the user input to the preset image (e.g., in the lock screen) or the input of the preset type (e.g., pattern) is detected.

Upon detecting the input for displaying the shortcut object, the electronic device can display a pop-up shortcut object 505 as shown in FIG. 5B. The shortcut objects corresponding to the web browser, the message, the e-mail, and the camera function are popped up in the unlock mode in the screen 503 (the user interface corresponding to the applications). According to various embodiments of the present disclosure, the pop-up shortcut object 505 may include objects corresponding to various other functions. The pop-up shortcut object 505 can also include a menu (e.g., a close menu (e.g., X mark)) for hiding the display.

The display of the pop-up shortcut object 505 implies that the lock function is released and concurrently that the particular application or function is ready to execute. The display of the pop-up shortcut object 505 helps the user to omit the check on the particular application to execute while turning over the page including the user interface. In other words, display of the pop-up shortcut object 505 eliminates the need for the user to navigate the user interface to search for the particular application to execute.

Accordingly, the user selects the shortcut object corresponding to the application or the function to execute from the displayed shortcut objects, and, as illustrated in FIG. 5C, the electronic device executes the application corresponding to the shortcut object selected by the user. As illustrated in FIG. 5C, the user has selected the shortcut object corresponding to the camera function from the displayed shortcut objects, and the electronic device executes the camera function.

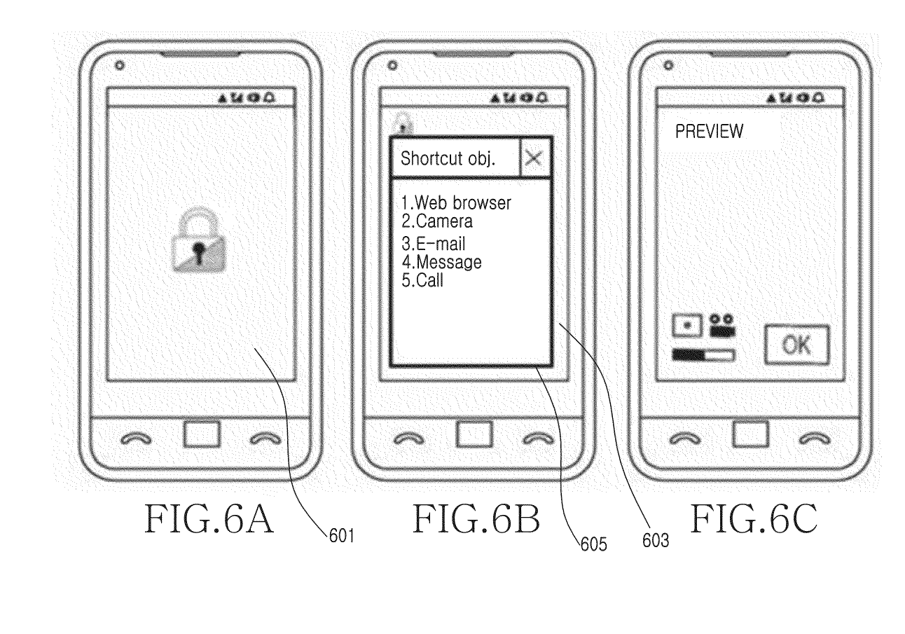

FIGS. 6A, 6B, and 6C are diagrams of screens of an electronic device for executing an application using a shortcut object according to an embodiment of the present disclosure.

Referring to FIGS. 6A, 6B, and 6C, the electronic device displays the shortcut objects according to the user input in the lock mode.

Referring to FIG. 6A, the electronic device displays a lock screen 601 indicating the lock mode.

When the lock screen is displayed, the electronic device can release the lock function according to the user input, or can release the lock function and display the shortcut object at the same time.

The shortcut object can be displayed when the user input to the preset image (e.g., in the lock screen) or the input of the preset type (e.g., pattern) is detected.

Upon detecting the input for displaying the shortcut object, the electronic device can display a pop-up shortcut object 605 as shown in FIG. 6B. The shortcut objects 605 corresponding to the web browser, the message, the message, the e-mail, and the camera function are popped up in the lock screen 603 including a lock icon. According to various embodiments of the present disclosure, the shortcut object 605 may include objects corresponding to various other functions. The pop-up shortcut object 605 can also include the menu (e.g., close menu (e.g., X mark)) for hiding the display.

The display of the pop-up shortcut object 605 implies that the lock function is released and concurrently that the particular application or function is ready to execute. The display of the pop-up shortcut object 605 helps the user to omit the check on the particular application to execute while turning over the page including the user interface. In other words, display of the pop-up shortcut object 605 eliminates the need for the user to navigate the user interface to search for the particular application to execute.

Accordingly, the user selects the shortcut object corresponding to the application or the function to execute from the displayed shortcut objects, and, as illustrated in FIG. 6C, the electronic device executes the application corresponding to the shortcut object selected by the user. As a result, the electronic device can control to release the lock after the shortcut object of the application to execute is selected. As illustrated in FIG. 6C, the user has selected the shortcut object corresponding to the camera function from the displayed shortcut objects, and the electronic device executes the camera function.

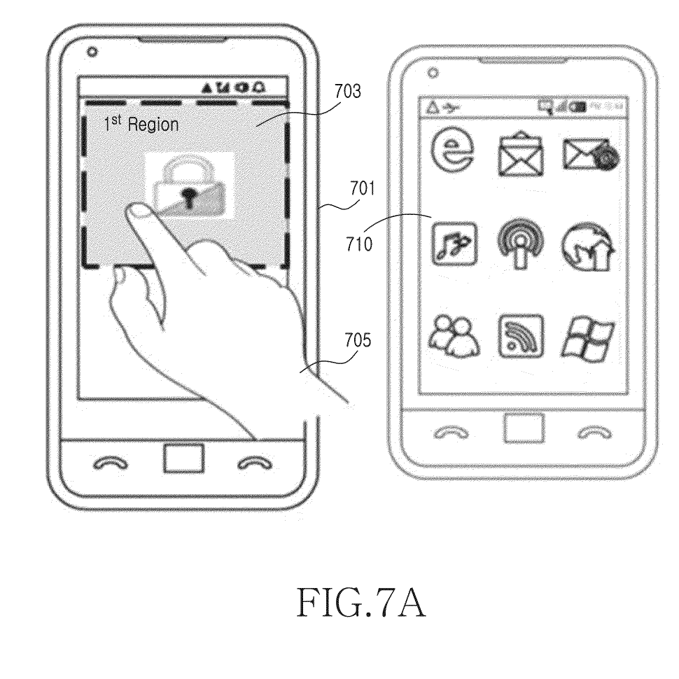

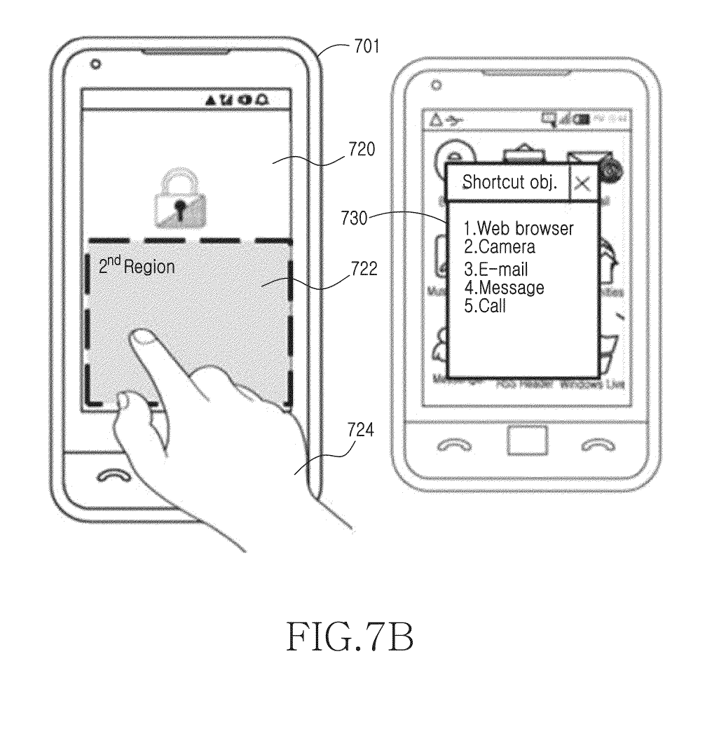

FIGS. 7A and 7B are diagrams of lock release by controlling a lock screen control in an electronic device according to an embodiment of the present disclosure.

FIG. 7A depicts the lock release by controlling the lock screen in the electronic device according to an embodiment of the present disclosure.

Referring to FIG. 7A, the electronic device 701 displays the lock screen indicating the lock mode. Part of the displayed lock screen is defined as a first region (image) 703 for the lock release.

According to various embodiments of the present disclosure, when a user input 705 is detected in the lock release region 703, the electronic device 701 releases the lock and then displays a user interface 710 corresponding to applications to thus notify (e.g., provide an indication of) the lock release. This process is the same as the general lock release.

FIG. 7B depicts the lock release by controlling the lock screen in the electronic device according to an embodiment of the present disclosure.

Referring to FIG. 7B, the electronic device displays a lock screen 720 indicating the lock mode. Part of the displayed lock screen is defined as a second region (image) 722 for displaying the shortcut object.

When a user input 724 is detected in the shortcut object display region, the electronic device 701 releases the lock and then displays a user interface corresponding to applications. In addition, the electronic device 701 displays the shortcut object 730 at the point of the lock release, and controls to execute a particular application or function using the displayed shortcut object.

For example, the electronic device 701 can display the lock screen including the lock release region (image) and the shortcut object display region (image), and then release the lock or display the shortcut object according to the user input.

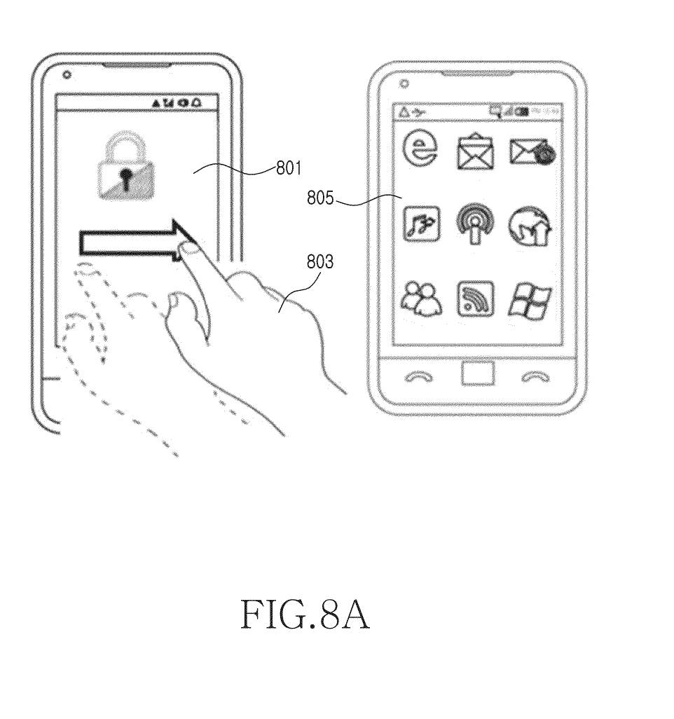

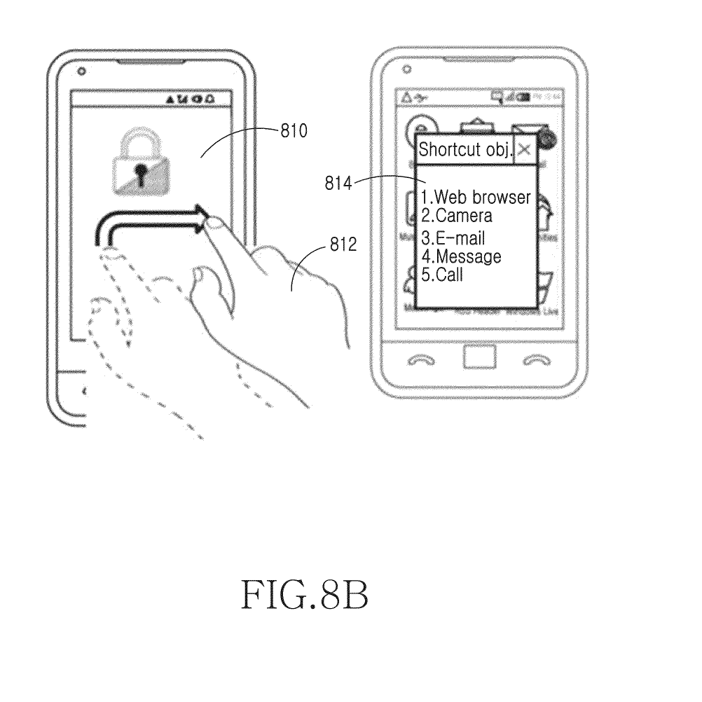

FIGS. 8A and 8B are diagrams of a lock release by controlling a lock screen control in an electronic device according to an embodiment of the present disclosure.

FIG. 8A depicts the lock release by controlling the lock screen in the electronic device according to an embodiment of the present disclosure.

Referring to FIG. 8A, the electronic device displays a lock screen 801 indicating the lock mode. The electronic device stores the input pattern for the lock release.

When detecting the same user input (e.g., the touch input from left to right) 803 as the stored input pattern of the lock release in the lock screen, the electronic device releases the lock, and then notifies (e.g., provides an indication of) the lock release by displaying a user interface 805 corresponding to the applications. This process is the same as the general lock release. According to various embodiments of the present disclosure, upon detecting a user input when the electronic device is in a lock mode, the electronic device determines whether the detected input corresponds to an input stored as an input pattern to release the lock.

FIG. 8B depicts the lock release by controlling the lock screen in the electronic device according to an embodiment of the present disclosure.

Referring to FIG. 8B, the electronic device displays a lock screen 810 indicating the lock mode. The electronic device prestores the input pattern for displaying the shortcut object.

When detecting the same user input (e.g., the touch input moving upward and then to right) 812 as the stored input pattern of the shortcut object display in the lock screen, the electronic device releases the lock and then displays a user interface corresponding to the applications. In addition, the electronic device displays the shortcut object 814 at the point of the lock release and controls to execute a particular application or function using the displayed shortcut object. According to various embodiments of the present disclosure, upon detecting a user input when the electronic device is in a lock mode, the electronic device determines whether the detected input corresponds to an input stored as an input pattern to contemporaneously release the lock and display the shortcut object.

For example, the electronic device can store the input pattern of the lock release and the input pattern of the displayed shortcut object, and then release the lock or display the shortcut object according to the user input.

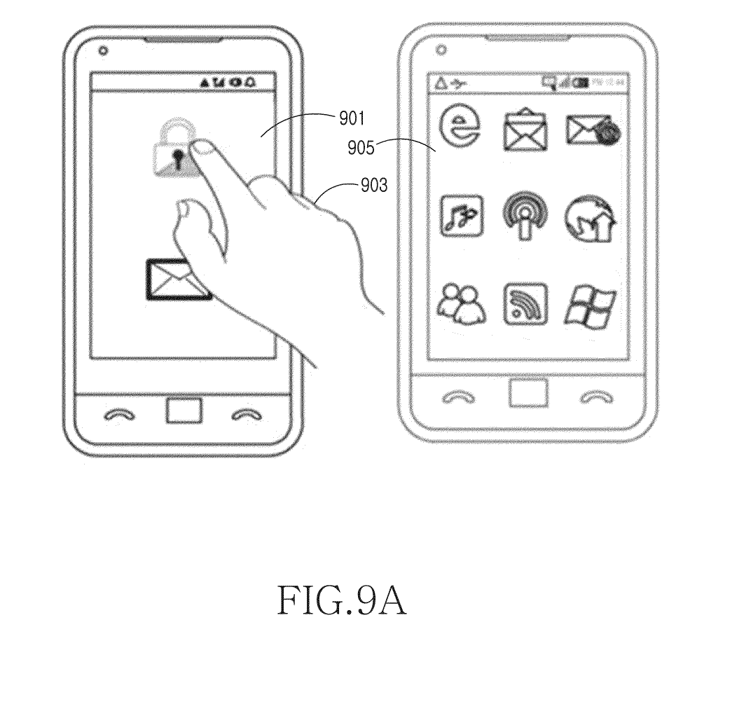

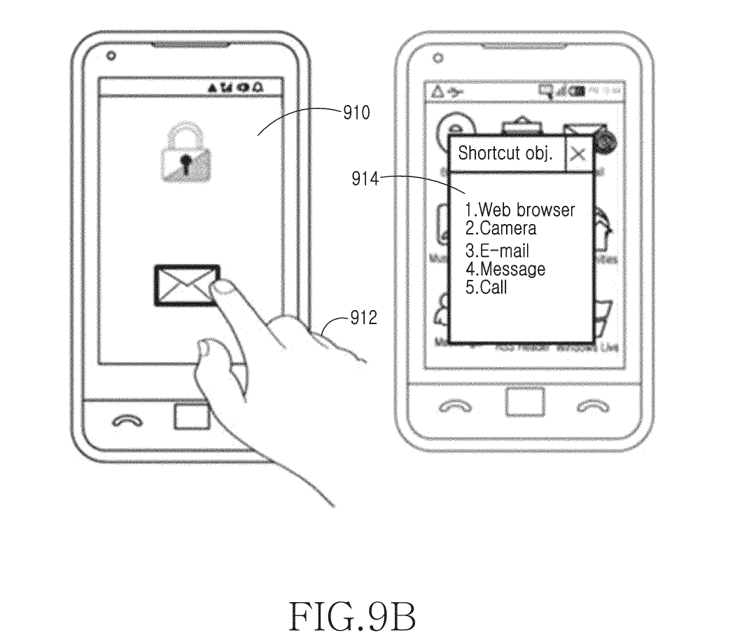

FIGS. 9A and 9B are diagrams of a lock release by controlling a lock screen control in an electronic device according to an embodiment of the present disclosure.

FIG. 9A depicts the lock release by controlling the lock screen in the electronic device according to an embodiment of the present disclosure.

Referring to FIG. 9A, the electronic device displays a lock screen 901 indicating the lock mode. Part of the displayed lock screen includes a first region (image) for the lock release and a second region (image) for displaying the icon of the application execution. According to various embodiments of the present disclosure, the second region generally displays information about the received message, the missed call, and/or the like in the lock mode, as icon information of the shortcut application in the lock mode.

When a user input 903 is detected in the lock release region, the electronic device releases the lock and then displays a user interface 905 corresponding to applications to notify (e.g., provide an indication of) the lock release. This process is the same as the general lock release.

FIG. 9B depicts the lock release by controlling the lock screen in the electronic device according to an embodiment of the present disclosure.

Referring to FIG. 9B, the electronic device displays a lock screen 910 indicating the lock mode. Part of the displayed lock screen is defined as the second region (image) for displaying the icon for the application execution. For example, the second region may display information about the received message, the missed call, and/or the like in the lock mode, as icon information of the shortcut application in the lock mode. The second region may display indicators for providing indication of various status updates relating to calendar information, communication information (e.g., call information, email information, text information, and instant message information), Social Networking Service (SNS) information, and/or the like.

When detecting a user input 912 in the shortcut object display region, the electronic device releases the lock and then displays a user interface corresponding to applications. In addition, the electronic device displays the shortcut object 914 at the point of the lock release, and controls to execute a particular application or function using the displayed shortcut object. Accordingly, while the electronic device can display the predefined shortcut object, the electronic device can display the icon displayed in the second region, as the shortcut object. For example, assuming that the second region of the lock screen displays the icons indicating the missed call, the received message, and/or the like, when detecting the user input in the second region, the electronic device displays a plurality of predefined shortcut objects 914 as shown in FIG. 9B or displays the shortcut object (not shown) for checking the missed call, the shortcut object (not shown) for checking the received message, and/or the like so that the user can select to check such information.

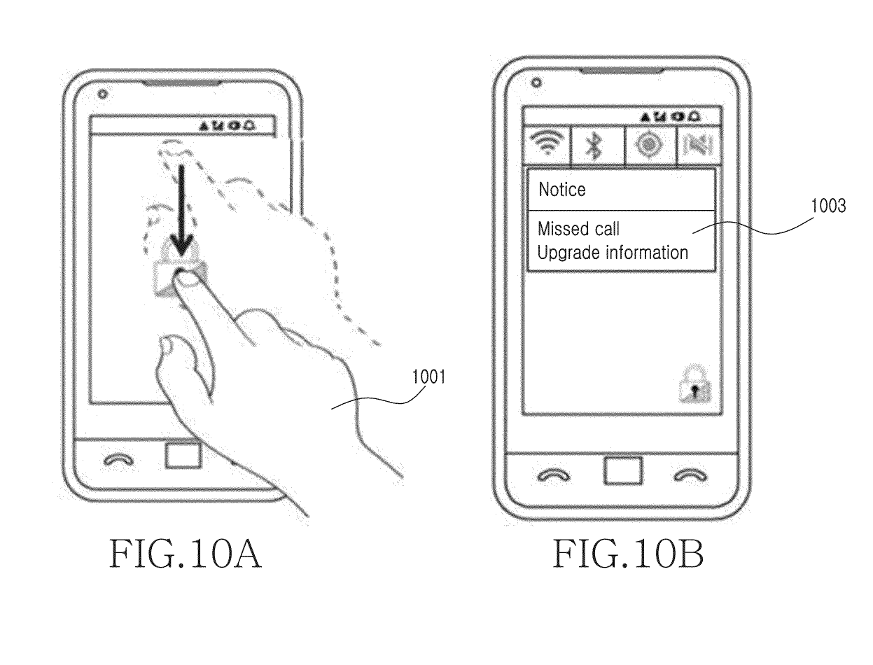

FIGS. 10A and 10B are diagrams of a lock screen control in an electronic device according to an embodiment of the present disclosure.

An electronic device according to the related art merely releases the lock in the lock mode. For example, the electronic device displays only the information indicating the user input pattern until the same user input as the prestored unlock pattern is detected.

In contrast, according to various embodiments of the present disclosure, the electronic device can display the status notification information according to the user input even in the lock mode. According to various embodiments of the present disclosure, the status notification information notifies the status (e.g., new message reception, update application information, and/or the like) of the electronic device 100 or the setting of the major function (e.g., wireless LAN, Bluetooth, GPS, and/or the like).

Referring to FIGS. 10A and 10B, the electronic device displays the lock screen indicating the lock mode and then detects the user input. The electronic device prestores the input pattern for displaying the status notification information and determines whether the same user input as the prestored pattern is detected.

When detecting the same user input 1001 as the prestored pattern, the electronic device displays the status notification information 1003 in the displayed lock screen as shown in FIG. 10B. As a result, the electronic device can display the status notification information by adding a separate layer in the lock screen. As illustrated in FIG. 10B, the missed call and the upgrade information are notified and the status notification information indicating the setting of the major functions is displayed together with the lock screen including the lock icon. Accordingly, the electronic device can omit the lock release and notify a status thereof (e.g., new message reception, update application information, and/or the like) or the setting of the major function (e.g., wireless LAN, Bluetooth, GPS, and/or the like) to thus change the setting.

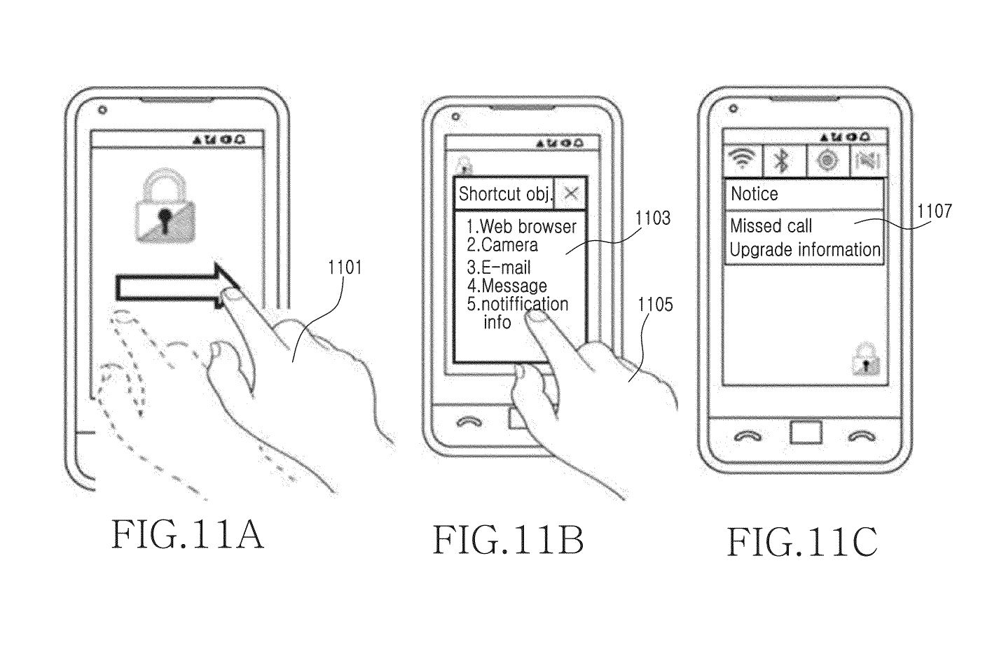

FIGS. 11A, 11B, and 11C are diagrams of a lock screen control in an electronic device according to an embodiment of the present disclosure.

Referring to FIGS. 11A, 11B, and 11C, the electronic device displays the lock screen indicating the lock mode. The electronic device prestores the input pattern for releasing the lock and the input pattern for displaying the shortcut object.

When detecting the same user input as the prestored input pattern of the lock release in the lock screen, the electronic device releases the lock and then notifies the lock release by displaying the user interface corresponding to the applications. This process is the same as the general lock release.

When detecting the same user input 1101 as the prestored input pattern of the shortcut object display in the lock screen as shown in FIG. 11A, the electronic device displays a shortcut object 1103 in the lock screen as shown in FIG. 11B to execute a particular application or function using the displayed shortcut object. In FIG. 11B, the shortcut object of the applications corresponding to the web browser, the camera, the e-mail, and the message and the shortcut object for displaying the status notification information are displayed. According to various embodiments of the present disclosure, the shortcut objects may include objects corresponding to various other functions. The electronic device displays the user interface corresponding to the applications after releasing the lock, and displays the shortcut object at the point of the lock release and controls to execute a particular application or function using the displayed shortcut object.

According to various embodiments of the present disclosure, the electronic device can select the shortcut object and execute the corresponding application, or display status notification information 1107 when the shortcut object for displaying the status notification information is selected by user input 1105 as shown in FIG. 11C.

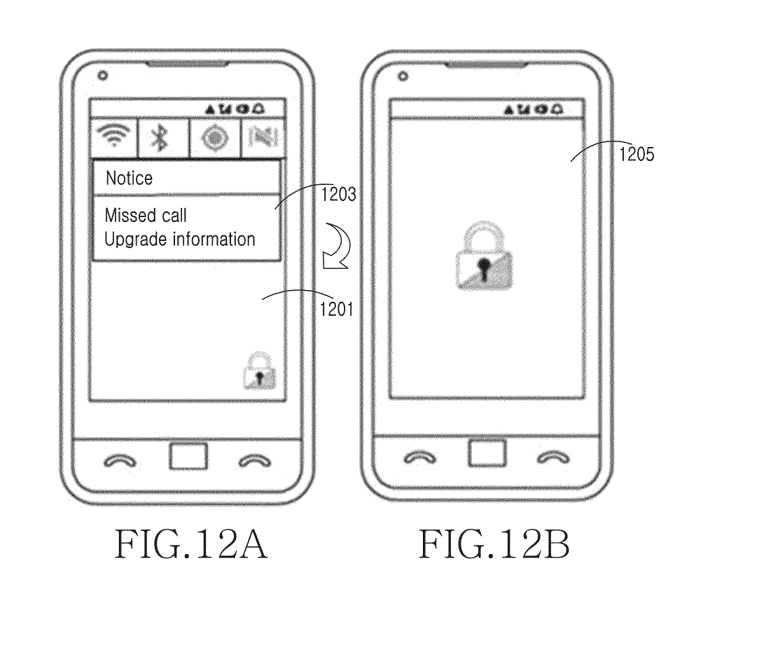

FIGS. 12A and 12B are diagrams of a displayed status notification information controlled in an electronic device according to an embodiment of the present disclosure.

Referring to FIGS. 12A and 12B, the electronic device can control the displayed status notification information in the lock mode. The status notification information can be controlled by hiding or controlling the status notification information.

According to various embodiments of the present disclosure, the electronic device displays the status notification information 1203 according to the user input in a lock screen 1201 indicating the lock mode as shown in FIG. 12A. The status notification information is displayed by adding a separate layer to the lock screen. The status notification information indicating the missed call, the upgrade information, the setting of the major functions, and/or the like is displayed together with the lock screen including the lock icon.

To control the displayed status notification information, the electronic device checks (e.g., determines) the status thereof. According to various embodiments of the present disclosure, the electronic device can control the displayed status notification information using the tilt information or the rotation information. For example, when detecting the tilt or the rotation over the threshold, the electronic device can determine the status for controlling the displayed status notification information. According to various embodiments of the present disclosure, the tilt information or the rotation information is used to control the status notification information, which can change the status of the electronic device in the user's hand. For example, the electronic device can detect a particular button input (e.g., volume button) in the user's hand or a pressure of the finger on the touch screen and use the input as the status notification information control information.

As such, upon checking (e.g., determining) the status to control the displayed status notification information, the electronic device hides the status notification information and displays the lock screen 1205 as shown in FIG. 12B.

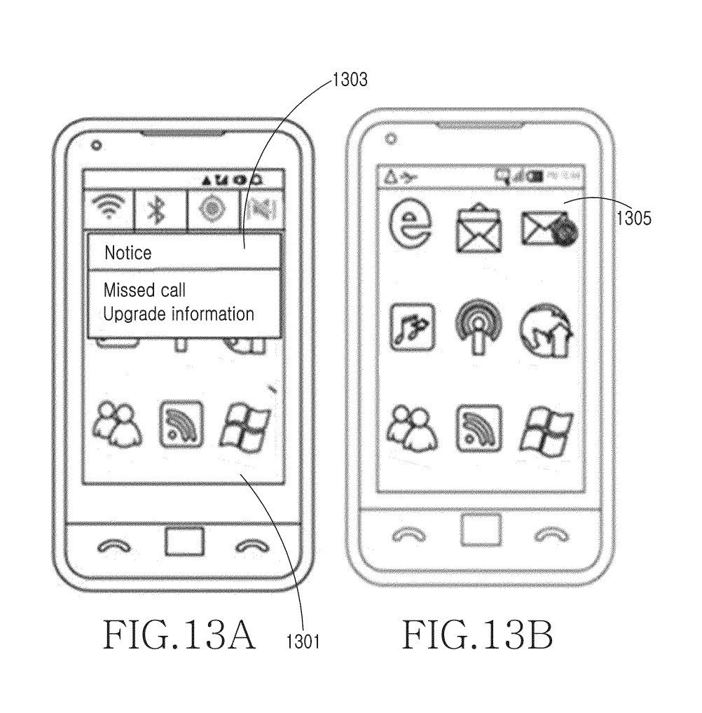

FIGS. 13A and 13B are diagrams of a displayed status notification information controlled in an electronic device according to an embodiment of the present disclosure;

Referring to FIGS. 13A and 13B, the electronic device can control the displayed status notification information in the unlock mode. The status notification information can be controlled by hiding or scrolling the status notification information.

As an example, the electronic device displays the status notification information 1303 according to the user input in an unlock mode 1301 as shown in FIG. 13A. The status notification information is displayed by adding a separate layer to the unlock interface. The status notification information indicating the missed call, the upgrade information, the setting of the major functions, and/or the like is displayed.

To control the displayed status notification information, the electronic device checks (e.g., determines) the status thereof. According to various embodiments of the present disclosure, the electronic device can control the displayed status notification information using the tilt information or the rotation information. For example, when detecting the tilt or the rotation over the threshold, the electronic device can determine the status for controlling the displayed status notification information. According to various embodiments of the present disclosure, the tilt information or the rotation information is used to control the status notification information, which can change the status of the electronic device in the user's hand. For example, the electronic device can detect the particular button input (e.g., volume button) in the user's hand or the pressure of the finger on the touch screen, and use the input as the status notification information control information.

Upon checking (e.g., determining) the status to control the displayed status notification information, the electronic device hides the status notification information and displays the unlock interface 1305 as shown in FIG. 13B.

When the user displays the status notification information by dragging a status bar in person and then hides the status notification information, the user does not have to drag the bar in the opposite direction of the status notification information display.

For example, the electronic device detects the user touch input on the touch screen, and determines whether the touch input is detected in the status bar.

Thereafter, the electronic device detects the user drag input, and displays the status notification information in the drag direction.

As a result, the electronic device displaying the status notification information detects a motion thereof through the sensing part capable of obtaining the tilt information or the rotation information, and determines whether the detected motion satisfies the condition for hiding the status notification information.

When the motion satisfies the condition for hiding the status notification information, the electronic device hides the status notification information.

Thus, the user can make the displayed status notification information disappear from the screen automatically by shaking or rotating the electronic device in one direction.

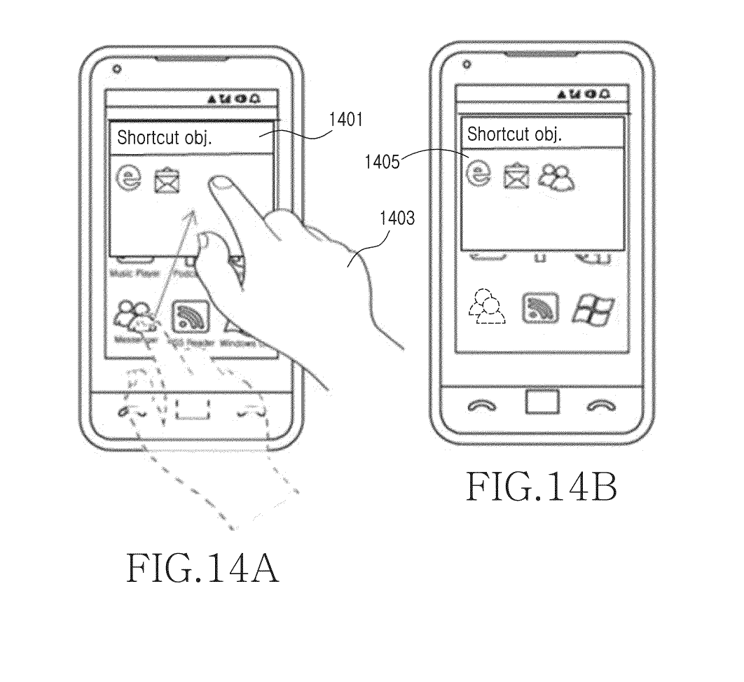

FIGS. 14A and 14B are diagrams of screens defining a shortcut object in an electronic device according to an embodiment of the present disclosure.

Referring to FIGS. 14A and 14B, the electronic device can display the shortcut object in the lock mode of the unlock mode and rapidly execute the intended application.

According to various embodiments of the present disclosure, the electronic device can identify and define the application executed in a certain time as the shortcut object.

According to various embodiments of the present disclosure, the electronic device can define the shortcut object based on the frequency of use during a certain time period.

According to various embodiments of the present disclosure, the electronic device can define information designated by the user as the shortcut object.

For example, the electronic device can define the icon selected by the user among the displayed application icons, as the shortcut object as shown in FIG. 14A.

First, the user of the electronic device generates a folder 1401 of the shortcut object and defines the shortcut objects by dragging an intended icon into the generated folder.

When the user drags the icon into the folder by user input 1403, the shortcut object updates the new icon 1405 as shown in FIG. 14B. In contrast, the user of the electronic device can delete and exclude the icon of the folder from the shortcut object.

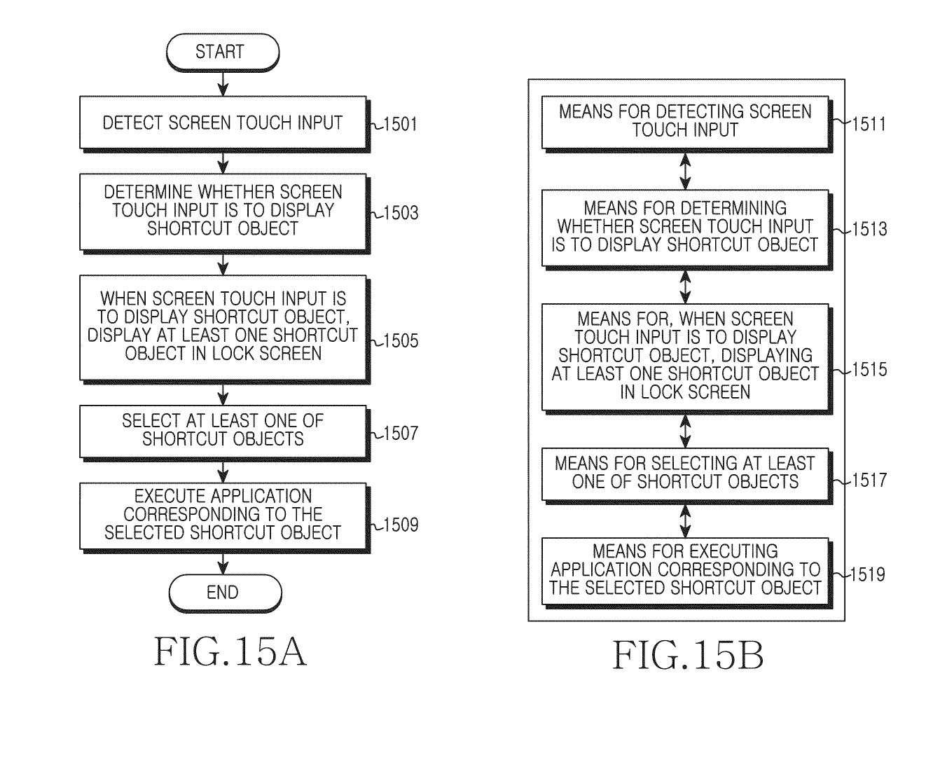

FIG. 15A is a flowchart of a method for controlling a screen in an electronic device according to an embodiment of the present disclosure.

Referring to FIG. 15A, at operation 1501, the electronic device detects the screen touch input.

At operation 1503, the electronic device determines whether the screen touch input is to display the shortcut object.

At operation 1505, the electronic device displays at least one shortcut object in the lock screen when the screen touch input is to display the shortcut object.

At operation 1507, the electronic device selects at least one of the shortcut objects.

At operation 1509, executes the application corresponding to the selected shortcut object.

At operation 1501, the electronic device detects the user touch input on the touch screen. The electronic device detects the touch input in the preset region (e.g., the region displaying the shortcut object) and the touch input corresponding to the prestored input pattern.

At operation 1503, the electronic device classifies the detected screen touch input. The electronic device can classify the screen touch input by checking the region of the detected screen touch input in the lock screen (image) including the lock release region (image) and the shortcut object display region (image).

Alternatively, the electronic device can prestore the input pattern for releasing the lock and the input pattern for displaying the shortcut object, and classify the screen touch input by comparing the input pattern (touch input type) detected in the lock mode (the lock screen) with the prestored input pattern.

When the screen input pattern is to display the shortcut object, the electronic device displays the preset shortcut object in the lock screen at operation 1505. According to various embodiments of the present disclosure, the electronic device can display the pop-up shortcut object.

At operations 1507 and 1509, the electronic device executes the application or the function corresponding to the shortcut object selected by the user among the displayed shortcut objects.

An instruction set of each operation of FIG. 15A can be included to the lock program, the gesture analysis program, and the display program of the memory 110 of FIG. 1, and the programs can be executed by one or more processors.

FIG. 15B is a diagram of an apparatus of an electronic device for controlling a screen according to an embodiment of the present disclosure.

Referring to FIG. 15B, the apparatus can include a means 1511 for detecting the screen touch input, a means 1513 for determining whether the screen touch input is to display the shortcut object, a means 1515 for displaying at least one shortcut object in the lock screen when the screen touch input is to display the shortcut object, a means 1517 for selecting at least one of the shortcut objects, and a means 1519 for executing the application corresponding to the selected shortcut object.

The means 1511 for detecting the screen touch input detects the user touch input on the touch screen. The means 1511 detects the touch input in the preset region (e.g., the region displaying the shortcut object) and the touch input corresponding to the prestored input pattern.

The means 1513 for determining whether the screen touch input is to display the shortcut object classifies the detected screen touch input. The means 1513 can classify the screen touch input by checking the region of the detected screen touch input in the lock screen (image) including the lock release region (image) and the shortcut object display region (image).

Alternatively, the means 1513 can prestore the input pattern for releasing the lock and the input pattern for displaying the shortcut object, and classify the screen touch input by comparing the input pattern (touch input type) detected in the lock mode (the lock screen) with the prestored input pattern.

When the screen input pattern is to display the shortcut object, the means 1515 for displaying at least one shortcut object in the lock mode displays the preset shortcut object in the lock screen. According to various embodiments of the present disclosure, the means 1515 can display the pop-up shortcut object.

The means 1517 for selecting at least one of the shortcut objects and the means 1519 for executing the application corresponding to the selected shortcut object execute the application or the function corresponding to the shortcut object selected by the user among the displayed shortcut objects.

Those means can be constructed as separate hardware or a single hardware.

The electronic device for controlling the lock status can include following elements.

The electronic device can include a Graphical User Interface (GUI) such as lock screen for displaying the lock mode. The GUI can include the region (image) for the lock release and the region (image) for releasing the lock and for executing the corresponding application at the same time.

The electronic device can include the user input (gesture) for releasing the lock. The user input can include the gesture in the preset region and the gesture of the preset type.

The electronic device can include the shortcut application which is executed immediately after the lock release.

The electronic device can include the shortcut object list which is executed after the lock release. The list can be displayed as the page or the popup. The displayed list can be hidden at the timer expiration or according to a user request.

The electronic device can include the shortcut object for linking the list and the application.

The electronic device can include the same elements for the status notification information.

As set forth above, the electronic device and the method for displaying the shortcut object displays the shortcut object in the lock mode or the unlock mode so as to execute the user intended application quickly and accurately. Further, the setting of the electronic device can be simplified by checking (e.g., determining) the status notification information in the lock mode.

It will be appreciated that various embodiments of the present disclosure according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are various embodiments of non-transient machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and various embodiments suitably encompass the same.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device comprising:
detecting a screen touch input;
when detecting the screen touch input for displaying at least one shortcut object in a lock screen, displaying at least one shortcut object;
selecting at least one of the at least one shortcut object; and
executing an application corresponding to the selected shortcut object.

2. The method of claim 1, wherein the screen touch input for displaying the at least one shortcut object touches the lock screen in a preset pattern.

3. The method of claim 1, wherein the displayed at least one shortcut object is a separate layer which is popped up in part of the lock screen.

4. The method of claim 1, wherein the displayed at least one shortcut object is displayed in the whole screen of the electronic device.

5. The method of claim 1, wherein the displayed at least one shortcut object is positioned along at least one screen edge of the screen of the electronic device.

6. The method of claim 1, wherein the displayed at least one shortcut object comprises at least one of status notification information indicating a status of the electronic device, an object for executing a function of the electronic device, and an object for executing the application.

7. The method of claim 1, wherein the display of the at least one shortcut object is hidden according to a motion detected in the electronic device.

8. The method of claim 1, wherein the display of the at least one shortcut object is hidden according to a touch input of a user in a particular region.

9. The method of claim 1, wherein the at least one shortcut object is displayed in at least one of a lock mode and an unlock mode.

10. A non-transient computer-readable storage medium storing instructions, that, when executed, cause at least one processor to perform the method of claim 1.

11. An electronic device for controlling a screen, the electronic device comprising:
a display; and
at least one processor,
wherein the at least one processor controls to detect a screen touch input, to display at least one shortcut object when detecting the screen touch input for displaying at least one shortcut object in a lock mode, to select at least one of the at least one shortcut object, and to execute an application corresponding to the selected shortcut object.

12. The device of claim 11, wherein the at least one processor controls to detect the screen touch input for displaying the at least one shortcut object, which touches the lock screen in a preset pattern.

13. The device of claim 11, wherein the at least one processor controls to display the at least one shortcut object being a separate layer which is popped up in part of the lock screen.

14. The device of claim 11, wherein the at least one processor controls to display the at least one shortcut object in the whole screen of the electronic device.

15. The device of claim 11, wherein the at least one processor controls to display the at least one shortcut object which is positioned along at least one screen edge of the screen of the electronic device.

16. The device of claim 11, wherein the at least one processor controls to display at least one of status notification information indicating a status of the electronic device, an object for executing a function of the electronic device, and an object for executing the application, as the shortcut object.

17. The device of claim 11, wherein the at least one processor controls to hide the display of the at least one shortcut object according to a motion detected by the electronic device.

18. The device of claim 11, wherein the at least one processor controls to hide the display of the at least one shortcut object according to a touch input of a user in a particular region.

19. The device of claim 11, wherein the at least one processor controls to display the at least one shortcut object in at least one of a lock mode and an unlock mode.

20. A method for controlling a lock function of an electronic device that comprises a touch screen, the method comprising:
detecting an input to the touch screen;
determining whether the detected input corresponds to a preset input for displaying a shortcut object from a lock mode;
displaying the shortcut object from the lock screen according to the detected input;
detecting an input for selecting the shortcut object; and
executing a function corresponding to the selected shortcut object.

21. The method of claim 20, wherein the displaying of the shortcut object from the lock mode comprises:
displaying the shortcut object while the electronic device is in a locked mode.

22. The method of claim 20, wherein the displaying of the shortcut object from the lock mode comprises:
unlocking electronic device; and
displaying the shortcut object in an unlocked mode of the electronic mode.

23. The method of claim 22, wherein the electronic device is unlocked contemporaneously with the displaying of the shortcut object.

24. The method of claim 20, wherein the determining of whether the detected input corresponds to the preset input for displaying the shortcut object from a lock screen comprises:
determining whether the detected input corresponds to a preset input for unlocking the electronic device; and
unlocking the electronic device if the preset input corresponds to the preset input for unlocking the electronic device.
